(19) United States
(12) Patent Application Publication
(10) Pub. No.: US 2007/0089626 A1
(43) Pub. Date: Apr. 26, 2007

(54) Functional ink apparatus and method

(75) Inventors: Amjad S. Rasul, Schaumburg, IL (US); Paul W. Brazis, South Elgin, IL (US); Daniel R. Gamota, Palatine, IL (US); Andrew F. Skipor, West Chicago, IL (US); Jie Zhang, Buffalo Grove, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Motorola, Inc.

(21) Appl. No.: 11/259,580

(22) Filed: Oct. 26, 2005

(51) Int. Cl. B41F 31/00

(52) U.S. Cl. 101/491

(57) ABSTRACT

A functional ink (200) suitable for use as a dielectric layer (303) in a printed semiconductor device (300) comprises a dielectric carrier (201) and a plurality of dielectric particles (202) sized less than about 1,000 nanometers that are disposed within the dielectric carrier. In a preferred approach the dielectric carrier comprises a dielectric resin and the dielectric particles comprise a ferroelectric material (such as, but not limited to, BaTiO₃. So provided, this functional ink can be applied to a substrate (301) of choice through a printing technique of choice to thereby provide a resultant printed semiconductor device, such as a field effect transistor, having a relatively thin dielectric layer comprised of this functional ink.

### TECHNICAL FIELD

This invention relates generally to printed semiconductor devices and more particularly to functional inks and dielectric materials as used therewith.

### BACKGROUND

Methods and apparatus that use such techniques as vacuum deposition to form semiconductor-based devices of various kinds are well known. Such techniques serve well for many purposes and can achieve high reliability, small size, and relative economy when applied in high volume settings. Recently, other techniques are being explored to yield semiconductor-based devices. For example, organic or inorganic semiconductor materials can be provided as a functional ink and used in conjunction with various printing techniques to yield printed semiconductor devices.

Printed semiconductor devices, however, yield considerably different end results and make use of considerably different fabrication techniques than those skilled in the art of semiconductor manufacture are prone to expect. For example, printed semiconductor devices tend to be considerably larger than typical semiconductor devices that are fabricated using more traditional techniques. As other examples, both the materials employed and the deposition techniques utilized are also well outside the norm of prior art expectations.

Due in part to such differences, in many cases existing materials and techniques are not suitable for use and deployment with respect to printed semiconductor devices. Further, in many cases, semiconductor device printing gives rise to challenges and difficulties that are without parallel in prior art practice. For example, one area of concern concerns the nature and quality of a dielectric layer as may be printed between a semiconductor layer and another device layer (or layers) (as when a dielectric layer serves to separate an organic semiconductor layer from a gate electrode and other device electrodes in a printed field effect transistor). Typically suggested polymer gate dielectric layers usually exhibit a relatively low dielectric constant (such as less than 5). This, in turn, can result in relatively low saturation current and therefore require higher device operating voltages. Higher operating voltage requirements can lead to numerous undesired design constraints.

In addition, the thickness of typical current dielectric layers is limited, at least in part, by the size of the filler particles that comprise a part of that dielectric layer. Such particles are normally larger than about 4 microns in diameter. It is also possible for the dielectric layer thickness to be at least partially set by the printing process itself. This relative thickness of the polymer dielectric layer further contributes (along with the aforementioned low dielectric constant) to an undesired low saturation current for a corresponding printed field effect transistor.

### BRIEF DESCRIPTION OF THE DRAWINGS

The above needs are at least partially met through provision of the functional ink apparatus and method described in the following detailed description, particularly when studied in conjunction with the drawings, wherein:

FIG. 1 comprises a flow diagram configured in accordance with various embodiments of the invention;

FIG. 2 comprises a schematic view of a functional ink as configured in accordance with various embodiments of the invention; and

FIG. 3 comprises a side elevational schematic view of an illustrative semiconductor device as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a functional ink suitable for use as a dielectric layer in a printed semiconductor device comprises a dielectric carrier and a plurality of dielectric particles sized less than about 1,000 nanometers that are disposed within the dielectric carrier. In a preferred approach the dielectric carrier comprises a dielectric resin and the dielectric particles comprise a ferroelectric material (such as, but not limited to, BaTiO₃). So provided, this functional ink can be applied to a substrate of choice through a printing technique of choice to thereby provide a resultant printed semiconductor device, such as a field effect transistor, having a dielectric layer comprised of this functional ink.

A corresponding resultant dielectric layer provides numerous advantages. These improvements include reducing the voltage required to operate the corresponding field effect transistor by increasing the saturation drain current. Benefits also include realizing a reduction in the thickness of the corresponding transistor. This functional ink tends to be compatible with numerous printing processes including both contact and non-contact printing and is also compatible with a variety of printing substrates including both substantially rigid and flexible plastic.

These and other benefits will become more evident to those skilled in the art upon making a thorough review and study of the following detailed description.

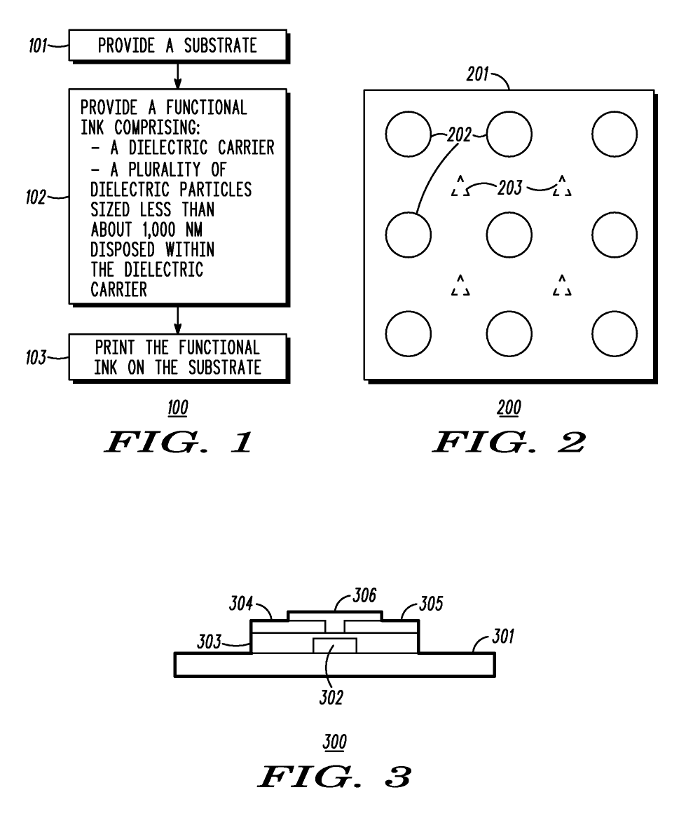

Referring now to the drawings, and in particular to FIG. 1, an overall process 100 representative of these various teachings first comprises providing 101 a substrate and more particularly a printing substrate. The substrate can comprise any suitable material including various rigid and non-rigid materials. In a preferred embodiment, the substrate comprises a flexible substrate comprised, for example, of plastic such as a polyester or a paper-like material such as paper, cardboard, or the like. The substrate can be comprised of a single substantially amorphous material or can comprise, for example, a composite of differentiated materials (for example, a laminate construct). In a typical embodiment the substrate will comprise an electrical insulator though for some applications, designs, or purposes it may be desirable to utilize a material (or materials) that tend towards greater electrical conductivity.

This process 100 further provides for the provision 102 of a functional ink comprising, preferably, a dielectric carrier having a plurality of dielectric particles sized less than about 1,000 nanometers disposed therein. (Those skilled in the printing arts are familiar with both graphic inks and so-called functional inks (wherein “ink” is generally understood to comprise a suspension, solution, or dispersant that is presented as a liquid, paste, or powder (such as a toner powder). These functional inks are further typically comprised of metallic, organic, or inorganic materials having any of a variety of shapes (spherical, flakes, fibers, tubes) and sizes ranging, for example, from micron to nanometer. Functional inks find application, for example, in the manufacture of some membrane keypads. Though graphic inks can be employed as appropriate in combination with this process, these inks are more likely, in a preferred embodiment, to comprise a functional ink.)

Referring momentarily to FIG. 2, the dielectric carrier 201 of this functional ink 200 can comprise a dielectric resin. The dielectric particles 202 are preferably comprised of ferroelectric material such as, but not limited to, BaTiO₃ (i.e., barium titanate). In an optional though preferred approach the dielectric particles 202 are disposed substantially homogenously within the dielectric carrier as is suggested by the illustration depicted. In a preferred approach the dielectric particles are quite small and are sized less than about 50 nanometers though good results may be obtained with larger values (up to about 1,000 nanometers) depending upon other requirements and restraints as may apply in a given application setting. More than one particle size can be used to enhance packing density of the particles in the cured dielectric film (using, for example, a bimodal barium titanate filler).(Barium titanate tends to be crystallographically tetragonal is form in particle sizes greater than about 250 nanometers but tends to be crystallographically cubic in form in particle sizes less than about 150 nanometers, thereby tending to make particles sized around 50 nanometers substantially intrinsically stable and hence likely giving rise to the aforementioned sizing preference.)

In an optional though preferred approach, the functional ink 200 may further comprise additional contents 203 such as, but not limited to, one or more dispersants and/or one or more surfactants as are known in the art to aid, for example, in dispersing the dielectric particles 202 throughout the dielectric carrier 201.

The relative quantity of dielectric particles 202 to dielectric carrier 201 can be varied to suit the specific materials employed and/or the specifics of a given application setting. That said, in general, these elements are present in respective quantities such that, following application via printing and subsequent curing, the plurality of dielectric particles 202 will comprise about 60% by volume of the functional ink 200.

Referring again to FIG. 1, this process 100 then provides for printing 103 this functional ink on the substrate. These teachings are compatible with both contact and non-contact printing processes of various kinds. Those familiar with traditional semiconductor fabrication techniques such as vacuum deposition will know that the word “printing” is sometimes used loosely in those arts to refer to such techniques. As used herein, however, the word “printing” is used in a more mainstream and traditional sense and does not include such techniques as vacuum deposition that involve, for example, a state change of the transferred medium in order to effect the desired material placement. Accordingly, “printing” will be understood to include such techniques as screen printing, offset printing, gravure printing, xerographic printing, flexography printing, inkjetting, roller coating, microdispensing, stamping, and the like. It will be understood that these teachings are compatible with the use of a plurality of such printing techniques during fabrication of a given element such as a semiconductor device. For example, it may be desirable to print a first device element (or portion of a device element) using a first ink and a first printing process and a second, different ink using a second, different print process for a different device element (or portion of the first device element).

Referring now to FIG. 3, it may be helpful to briefly describe how a transistor 300 can be formed using such materials and processes as follows. A gate 302 can be printed on a substrate 300 of choice using a conductive ink of choice (such as but not limited to a functional ink containing copper or silver, such as DuPont's Ag 5028 combined with 2% 3610 thinner). Pursuant to one approach, air is blown over the printed surface after a delay of, for example, four seconds. An appropriate solvent can then be used to further form, define, or otherwise remove excess material from the substrate. Thermal curing at around 120 degrees Centigrade for 30 minutes can then be employed to assure that the printed gate 302 will suitably adhere to the substrate 301.

A dielectric layer 303 may then be printed over at least a substantial portion of the above-mentioned gate 302 using a functional ink 200 as has been described above.

Additional electrodes 304 and 305 are then again printed and cured using, for example, a copper or silver-based electrically conductive functional ink (such as, for example, DuPont's Ag 5028 with 2% 3610 thinner). These additional electrodes can comprise, for example, a source electrode 304 and a drain electrode 305. A semiconductor material ink, such as but not limited to an organic semiconductor material ink such as various formulations of polythiophene or a polythiophene-based material such as poly(3-hexylthiophene) or an inorganic semiconductor material ink such as SnO₂, SnO, ZnO, Ge, Si, GaAs, InAs, InP, SiC, CdSe, and various forms of carbon (including carbon nanotubes), is then printed to provide an area of semiconductor material 306 that bridges a gap between the source electrode 304 and the drain electrode 305.

So configured the resultant dielectric layer will tend to be relatively thin. This, in turn, leads to an increased saturation drain current and a corresponding reduced operating voltage. These teachings are compatible with numerous printing processes and are also compatible with a variety of printing substrates including both substantially rigid substrates and flexible plastic substrates.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A functional ink comprising:
a dielectric carrier;
a plurality of dielectric particles sized less than about 1000 nanometers and being disposed within the dielectric carrier.

2. The functional ink of claim 1 wherein the dielectric carrier comprises a dielectric resin.

3. The functional ink of claim 1 wherein the plurality of dielectric particles are sized less than about 50 nanometers.

4. The functional ink of claim 1 wherein the plurality of dielectric particles are comprised of ferroelectric material.

5. The functional ink of claim 4 wherein the ferroelectric material comprises BaTiO₃.

6. The functional ink of claim 1 wherein the plurality of dielectric particles are disposed substantially homogenously within the dielectric carrier.

7. The functional ink of claim 1 further comprising at least one of a dispersant and a surfactant.

8. The functional ink of claim 1 wherein the dielectric carrier and the plurality of dielectric particles are present in respective quantities such that, following application via printing and curing, the plurality of dielectric particles comprise about 60% by volume of the functional ink.

9. A method comprising:
providing a substrate;
providing a functional ink comprising:
a dielectric carrier;
a plurality of dielectric particles sized less than about 1000 nanometers and being disposed within the dielectric carrier;
printing the functional ink on the substrate.

10. The method of claim 9 wherein the substrate comprises a flexible substrate.

11. The method of claim 10 wherein the flexible substrate comprises at least one of:
a paper-like substrate;
a plastic substrate.

12. The method of claim 9 wherein the plurality of dielectric particles are sized less than about 50 nanometers.

13. The method of claim 9 wherein the plurality of dielectric particles are comprised of ferroelectric material.

14. The method of claim 13 wherein the ferroelectric material comprises BaTiO₃.

14. The method of claim 9 wherein the plurality of dielectric particles are disposed substantially homogenously within the dielectric carrier.

15. The method of claim 9 wherein the functional ink further comprises at least one of a dispersant and a surfactant.

16. The method of claim 9 wherein printing comprises printing using at least one of a contact printing process and a non-contact printing process.

17. An apparatus comprising:
a substrate;
a printed dielectric layer on the substrate comprised of a functional ink comprising:
a dielectric carrier;
a plurality of dielectric particles sized less than about 200 nanometers and being disposed within the dielectric carrier.

18. The apparatus of claim 17 wherein the apparatus comprises a printed semiconductor device.

19. The apparatus of claim 17 wherein the plurality of dielectric particles are comprised of ferroelectric material.

20. The apparatus of claim 17 wherein the plurality of dielectric particles are disposed substantially homogenously within the dielectric carrier.
